(19) United States
(12) Patent Application Publication
(10) Pub. No.: US 2003/0108044 A1
(43) Pub. Date: Jun. 12, 2003

(54) Stateless TCP/IP protocol

(76) Inventor: Roland Hendel, San Francisco, CA (US)

Correspondence Address: Anthony T. Cascio, BURNS, DOANE, SWECKER & MATHIS, L.L.P., P.O. Box 1404, Alexandria, VA, 22313-1404, US

(21) Appl. No.: 10/014,172

(22) Filed: Dec. 11, 2001

(51) Int. Cl. H04L 12/28

(52) U.S. Cl. 370/392; 370/394

(57) ABSTRACT

A synchronization packet is preformed at a first device. The synchronization packet is to be transmitted to a second device through a connection over a computer network. The second device, in response to receiving the synchronization packet develops an acknowledgment packet to be transmitted back to the first device. The second device reads selected header information from the synchronization packet and re-uses this information for the header of the acknowledgment packet. The first and second device exchange a plurality of successively transmitted packets and a plurality of acknowledgment packets. For each packet to be developed and sent, the originator of the packet similarly reads the selected header information of the immediately prior received packet and re-uses this header information for the current packet. The first device may also preform a termination packet, and the second device acknowledges the termination packet in an acknowledgment packet that re-uses header information from the termination packet.

### BACKGROUND OF THE INVENTION

The present invention relates generally to communication protocols and more particularly to a novel stateless TCP/IP protocol.

Communication of data over the Internet between a pair of devices in communication with each is partially accomplished through the use of several layers of protocols or protocol stack. Generally, the stack includes the various application, protocol and communication layers that generate, encapsulate and transmit the data. The encapsulation generally places various headers on the data generated by an application program at the sending device to form a succession of packets for transmission into the Internet. The protocol stack at the receiving device is used, in reverse order, to strip such headers upon receipt of the packets so that the data can be reassembled and acted upon by another application program at the receiving device.

Generally, the top layer of the protocol stack is the application layer, followed by, in turn, the transport layer and network layer. Following the network layer is the data link layer and finally the access method layer which places the packet “onto the wire.”

In the application layer, a program executing in the sending device initiates communications intended for the receiving device using an application protocol, for example, the file transfer protocol or the simple mail transfer protocol. The application layer is responsible for obtaining the IP address of the receiving device, wherein the IP address includes the network address and the host station address. The application program at the sending device identifies the program it wishes to communicate with at the receiving device by its socket. The socket is a combination of the IP address of the receiving device and the port assigned to the program. A port is a logical number assigned to every program. A corresponding socket also exists at the sending device. The connection between the two devices is defined by the sockets.

The transport layer, for example using the Transmission Control Protocol (TCP), establishes a connection between the sending device and the receiving device before any data can be transmitted. Once established, a maximum packet size (generally limited by the allowable packet size of the data link layer) is negotiated between the two devices. TCP then attaches a header onto each packet, wherein the header contains, inter alia, the source port assigned to the program running at the sending device and the destination port assigned to the program running at the receiving device, as well as a sequence number of the packet. The sequence number is parsed by the stack at the receiving device to generate an acknowledgment packet sent back to the sending device. TCP then hands over the packet to the IP layer along with the IP address of the destination node.

The IP layer accepts the packets from TCP and prepares the packets for the data link protocol layer below by turning the IP addresses into physical station addresses, known to those skilled in the art as MAC addresses, and fragmenting the packets, if necessary, into a required frame size. Generally, the IP protocol broadcasts the IP address onto the network and the machine with that IP address responds with its MAC address. IP outputs packets called “datagrams,” and each datagram is prefixed with an IP header that contains the source IP address of the sending device and the destination IP address of the receiving device. The IP protocol is used to route the packets from network to network.

The IP datagrams are then handed over to the data link layer. The data link layer is responsible for reliable node to node transmission within a subnetwork.

As can generally be seen from the above example, a message developed by a program running at the first device goes down the protocol stack, over the wire, and then back up the stack on the receiving device. The counterpart protocols in the stack at the time receiving device unpackage the frames, datagrams and packets, and then deliver the transmitted data to the program running at the receiving device for processing. Many references exist describing in greater detail the use of sockets and stacks. However, of particular relevance herein, are the TCP/IP protocol layers.

The TCP/IP connection as described above relies upon the socket and stack being placed in memory for each of the sending and receiving devices. Accordingly, the TCP/IP connection relies upon a state at each of the sending and receiving devices. The states at each device govern the activity the receptive device is performing. Furthermore, these activities require significant use of the respective device's resources to process the packets as they move up and down the stacks. For example, for each packet to be sent the TCP and IP header information needs to be computed and determined, and for each packet received the TCP and IP header information needs to be parsed.

In order for a socket connection to be established, each of the devices must synchronize to each other's initial sequence number, the sequence number being another part of the TCP header. The synchronization is performed by an exchange of connection establishing segments, or packets, carrying a control bit “SYN” in the TCP header along with the initial sequence number. In any such packet wherein the control bit is set, the packet is commonly referred to as a SYN.

The synchronization requires each device to send its own initial sequence number and to receive a confirmation of it in an acknowledgment from the other device. The acknowledgment is also sent in a packet wherein another control bit, ACK, is set, and this packet is thus commonly referred to as an ACK. The confirming acknowledgment includes an acknowledgment number, also part of the TCP header, which is derived from the sequence number it is acknowledging. The SYN and ACK control bits may both be set in a single TCP header so that the resultant packet, called a SYN/ACK, performs both functions.

An example of such a synchronization exchange may be given as follows:

A--->B SYN (SEQ=X, CTRL=SYN)

B--->A SYN/ACK (SEQ=Y, ACK=X+1, CTRL SYN,ACK)

A--->B ACK (SEQ=X+1, ACK=Y+1, CTRL=ACK)

Initiating the connection, the first device, A, sends the SYN with a randomly generated initial sequence number of the first device, as indicated by SEQ=X, and the synchronization control bit set, as indicated by CTRL+SYN. Upon receiving the SYN, the second device, B, generates the SYN/ACK with a randomly generated initial sequence number of the second device, as indicated by SEQ+Y, an acknowledgment number acknowledging the first device's sequence number, as indicated by ACK=X+1, and both the synchronization and acknowledgment control bits set, as indicated by CTRL=SYN,ACK. Completing the connection, the first device then sends the ACK with an incremented sequence number, as indicated by SEQ=X+1, an acknowledgment number acknowledging the second device's sequence number, as indicated by ACK=Y+1, and the acknowledgment control bit set, as indicated by CTRL=ACK.

In the above example, the first device, A, and the second device, B, each went through a change of states. The first device, A, had an initial state, CLOSED, and the second device, B, had an initial state, LISTEN. The CLOSED state indicates the the device is idle, doing nothing, whereas the LISTEN state indicates the device is waiting to receive SYN'S. Upon the SYN being sent and received, the first device, A, then changed to a state, SYN-SENT, and the second device, B, changed to a state, SYN-RECEIVED, the description of each of these states being apparent from its acronym. When the SYN/ACK is sent and received, the first device, A, changes state to ESTABLISHED, indicating a connection can be established, and the second device, B, maintains the SYN-RECEIVED state. Finally, when the ACK is sent and received, the first device, A, is still in the ESTABLISHED state, and the second device, B, also goes to the ESTABLISHED state, completing the socket connection.

An exchange of data may now occur between the first device and the second device, using data packets which may also acknowledge receipt of the other device's data packet. The IP header of each packet also contains a length number, which indicates the total length of the packet including both the TCP/IP headers and the data or message. From the length number, the receiving device can determine the total number of units of data received, wherein such units may, for example, be bytes or octets. Each unit received corresponds to an increment of one sequence number. The received length number in conjunction with the received sequence number is then used to determine the ACK number to be sent, which indicates the next sequence number the receiving device expects to receive from the sending device.

When either device has no more data to send, it sets another control bit, FIN, in the TCP header, to generate a FIN packet, which also must be acknowledge as above. During this exchange, each device is also move through various other states, as is known. When each device has sent a FIN packet that becomes acknowledged, the connection is closed. The state of the two devices then revert to the initial closed and listen states described above.

As is readily apparent from the brief description of the TCP/IP protocol above, numerous computations need to be performed consuming significant system resources in the memory dependent, state oriented connection. Furthermore, the receiving device in the connection described above may typically be a server which needs to accept connections from many sending devices, which may typically be clients. Two important parameters for servers are their ability to accept new connections, typically measured by the rate at which the server may establish new connections, and the maximum number of connections that the server may maintain.

Accordingly, because of the resource intensive nature of TCP/IP connections, TCP/IP is disadvantageously limited within a testing environment to obtain empirical data relating to these parameters. For example, the processing time required at a server may not allow the maximum rate of establishing new connections to be obtained. Therefore, a need exists for a stateless TCP/IP protocol that is useful in the testing environment.

### SUMMARY OF THE INVENTION

An object of the present invention is to overcome one or more disadvantages and limitations of the prior art hereinabove enumerated. Another object of the present invention is to provide a novel TCP/IP protocol that does not rely on the state of a connection being maintained. According to one embodiment of the present invention, a synchronization packet is preformed at a first device. The synchronization packet is to be transmitted to a second device through a connection over a computer network. The second device, in response to receiving the synchronization packet develops an acknowledgment packet to be transmitted back to the first device. The second device reads selected header information from the synchronization packet and re-uses this information for the header of the acknowledgment packet. The first and second device exchange a plurality of successively transmitted packets and a plurality of acknowledgment packets. For each packet to be developed and sent, the originator of the packet similarly reads the selected header information of the immediately prior received packet and re-uses this header information for the current packet. The first device may also preform a termination packet, and the second device acknowledges the termination packet in an acknowledgment packet that re-uses header information from the termination packet.

A feature of the present invention is that by re-using header information between a received packet and the next to be sent packet, the state of a connection between a client and server need not be maintained. Another feature of the present invention is that intensive processing of the stack at each of the client and server need not be performed upon receipt and transmission of packets and acknowledgments. The protocol of the present invention is therefore highly advantageous in testing of connections and rate of forming connections in network devices.

These and other objects, advantages and features of the present invention will become readily apparent to those skilled in the art from a study of the following Description of an Exemplary Preferred Embodiment when read in conjunction with the attached Drawing and appended claims.

### BRIEF DESCRIPTION OF THE DRAWING

FIG. 1 is a schematic diagram of a computer system useful for practicing the present invention;

FIG. 2 is a format of a packet transmitted over the network of FIG. 1;

FIG. 3 is the format of a TCP header;

FIG. 4 is the format of an IP header;

FIG. 5A-C are flowcharts useful describe a method of the present invention; and

FIG. 6 is a schematic diagram of another computer system useful to practice the present invention in a testing environment.

### DESCRIPTION OF THE EXEMPLARY PREFERRED EMBODIMENTS

Referring now to FIG. 1, there is shown a computer system 10. The computer system 10 includes a first device 12, a second device 14 and a computer network 16. Each of the first device 12 and the second device 14 may be any of a personal computer, a workstation, a web server or any similar type of device. The computer network 16 is, in a preferred embodiment of the present invention, a public computer network such as the Internet, however, any computer network, in which communication between the first device 12 in the second device 14 is accomplished by the exchange of successively transmitted packets, is within the scope of the present invention. One such example is a public or private, local or wide area network using Ethernet packets for communication.

The packets are transmitted bidirectionally over the network 16 through a connection established between the first device 12 and the second device 14. Typically, a program executing at the first device 12 generates the data that is transmitted to the second device 14, and a program executing at the second device 14 utilizes such data. Conversely, the program executing at the second device 14 also generates other data that is transmitted to the first device 12, and the program executing at the first device 12 utilizes this other data. Each of the successively transmitted packets exchanged between the first device 12 and the second device 14 transmits units of the data generated by the respective programs at each of the first device 12 and the second device 14. These units of data may be measured as bytes, octets or any other convenient unit measurement of data known in the art.

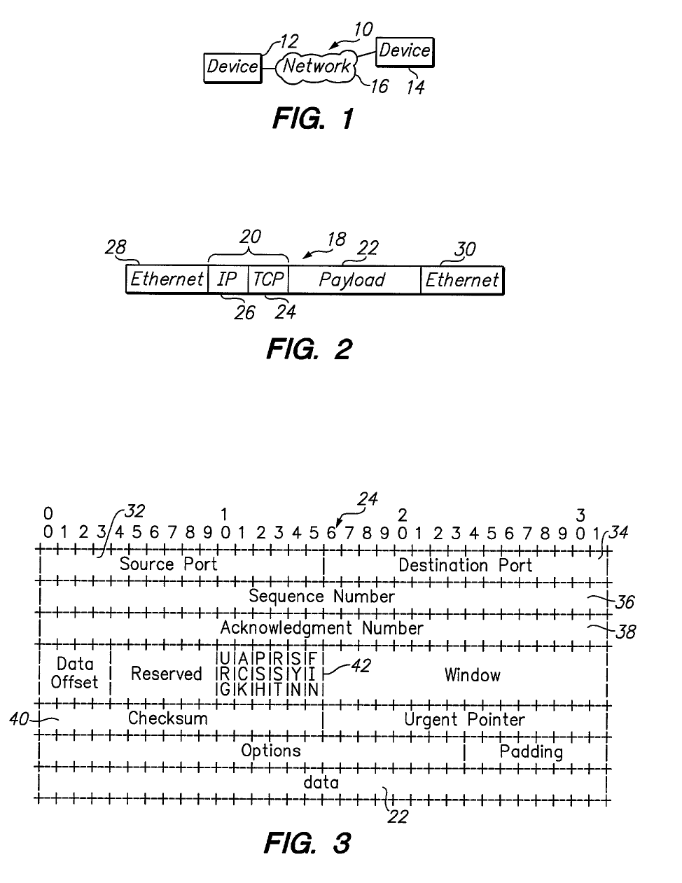

With reference now to FIG. 2, there is shown an exemplary packet 18. The exemplary packet 18 includes a header 20 and a payload 22. The payload 22 contains a selected number of the units of data being transmitted from one of the first device 12 and the second device 14 to the other of the first device 12 and the second device 14. The header 20 includes a TCP header 24 and an IP header 26. As is conventionally known, the packet 18 may also include a data link or MAC layer header such as an Ethernet header 28 and trailer 30 encapsulating a datagram defined by the header 20 and payload 22.

Referring now to FIG. 3, there is shown a detail of the TCP header 24. Although the details of the TCP header 24 are well known, reference is made herein below to certain fields of the TCP header 24. Specifically, the fields in the TCP header 24 of interest herein are a source port field 32, a destination port field 34, a sequence number field 36, an acknowledgment number field 38, a checksum field 40 and a control bit field 42.

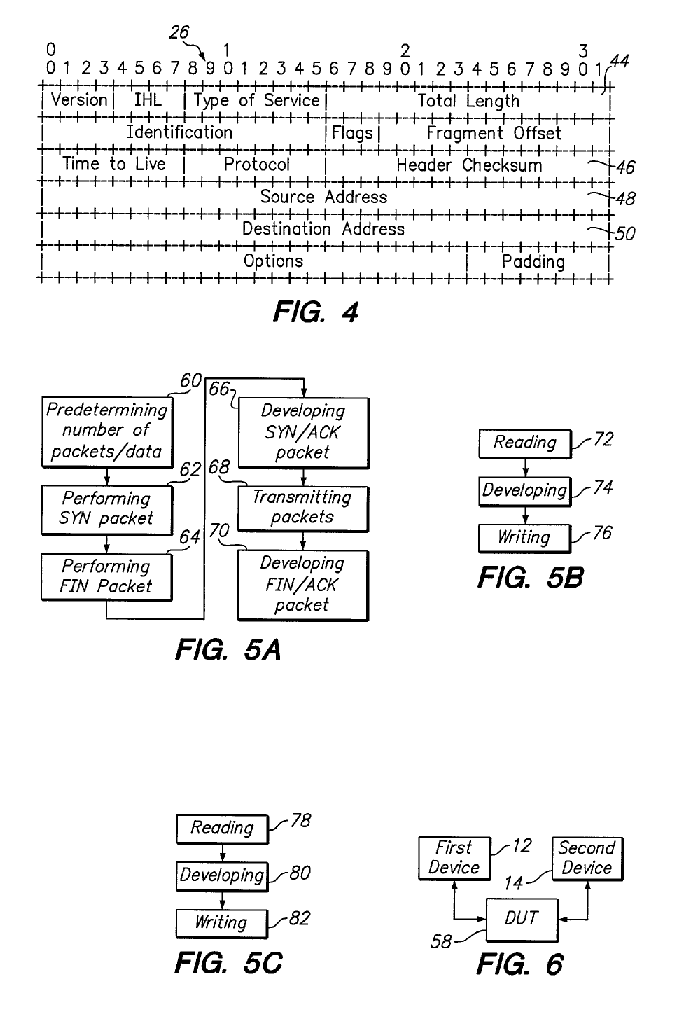

Referring also to FIG. 4, there is shown a detail of the IP header 26. Similarly, although the details of the IP header 26 are well known, reference is also made herein below to certain fields of IP header 26. Specifically, the fields in the IP header 26 of interest herein are a length field 44, a checksum field 46, a source address field 48 and a destination address field 50.

A complete description of the TCP header 24 may be found in RFC 793, Transmission Control Protocol, DARPA Internet Program, Protocol Specification, September 1981, and a complete description of the IP header 26 may be found in RFC 791, Internet Protocol, DARPA Internet Program, Protocol Specification, September 1981. However, the present invention utilizes the above referenced fields, or generates the content for these fields, in a manner not taught, suggested or disclosed within their respective protocol specifications.

For example, the above referenced TCP/IP protocol specifications require that the TCP/IP protocol be state driven, wherein a state of the connection be maintained in each of the first device 12 and the second device 14. However, it will become apparent to those skilled in the art from the description below that the novel TCP/IP protocol of the present invention is stateless. The novel TCP/IP protocol of the present invention does not rely upon a current state of the connection being stored in memory in either the first device 12 or second device 14. Other examples will become readily apparent from the following description.

In the computer system 10, in accordance with one embodiment of the present invention, the first device 12 and the second device 14 through a connection over the computer network 16 exchange a plurality of successively transmitted packets and a plurality of acknowledgment packets, wherein each of the packets is similar to the exemplary packet 18. For each of the successively transmitted packets sent from an originating one of the first device 12 and the second device 14 and received at a receiving one of the first device 12 and the second device 14, the receiving one sends a respective one of said acknowledgment packets to the originating one of the first device 12 and the second device 14.

In accordance with the present invention, a first one of the successively transmitted packets 18 is preformed at the first device 12. The header 20 of the first one of the packets includes predetermined information associated with establishing the connection between the first device 12 and the second device 14. The first one of the successively transmitted packets is to be transmitted to the second device 14.

In response to receiving the first one of the successively transmitted packets 18 at the second device 14, the second device 14 develops a first one of the acknowledgment packets. The header 20 of the first one of the acknowledgment packets includes complementary information associated with establishing the connection between the first device 12 and the second device 14. The first one of the acknowledgment packets is to be sent to the first device 12.

More particularly, to develop the first one of the acknowledgment packets the second device 12 reads selected portions of the header 20 of the first one of the successively transmitted packets and modifies these selected portions. The second device 14 then writes the selected portions, as modified, into the header 20 of the first one of the acknowledgment packets.

To develop the header 20 for each subsequent one of the successively transmitted packets sent by the originating one of the first device 12 and the second device 14, the originating one reads selected portions of the header 20 of a prior received one of the acknowledgment packets that has been received at the originating one in acknowledgment of an immediately prior one of the successively transmitted packets sent by the originating one. The originating one of the first device 12 and the second device 14 then modifies the selected portions from the prior received one of the acknowledgment packets of the header 20 of this particular one of the acknowledgment packets. The originating one of the first device 12 and the second device 14 then writes the selected portions, as modified, into the header 20 of the subsequent one of the successively transmitted packets to be sent by the originating one.

To develop the header 20 for each subsequent respective one of the acknowledgment packets, the receiving one of the first device 12 and the second device 14 read selected portions of the header 20 of the current one of the successively transmitted packets. The receiving one of the first device 12 and the second device 14 then modifies the selected portions from the header 20 of the current one of the successively transmitted packets. The receiving one of the first device 12 and the second device 14 then writes the selected portions from the header 20 of the current one of the successively transmitted packets, as modified, into the header 20 of the respective one of the acknowledgment packets.

A final one of the successively transmitted packets is also preformed at the first device to be transmitted to the second device. The header 20 of the final one of the successively transmitted packets includes predetermined information associated with terminating the connection between the first device 12 and the second device 14 over the network 16.

A final one of the acknowledgment packets is developed at the second device 14 in response to receiving the final one of the successively transmitted packets. The header 20 of the final one of the acknowledgment packets includes complementary information associated with terminating this connection.

More particularly, the second device 14 reads selected portions of the header 20 of the final one of the successively transmitted packets and modifies the selected portions from the final one of the successively transmitted packets. The second device 14 then writes the selected portions from the final one of the successively transmitted packets, as modified, into the header 20 of the final one of the acknowledgment packets.

Generally, the modifications referred to above may be a swapping of the contents, or the order of such contents from the header of one packet to the header of another packet. Alternatively, such modifications may take the contents from the header of one packet and alter its contents before being written to the header of another packet. It is one general intent of the present invention that header information from a received packet be re-used to the extent possible for insertion into the header of the next to be sent packet. Specific examples of such modifications are set forth below.

The preformed first one of the successively transmitted packets may be a synchronization packet wherein the header 20 of the synchronization packet includes a predetermined sequence number in the sequence number field 36 of the TCP header 24. The setting of the SYN bit in the control bit field 42 of the TCP header 24 establishes any packet 18 as a synchronization packet. When the second device 14 receives the synchronization packet, it reads the sequence number and increments the sequence number. The second device 14 then writes the incremented sequence number to the acknowledgment number field 38 of the TCP header 24 of the header 20 of the first one of the acknowledgment packets. The setting of the ACK bit in the control bit field 42 of the TCP header 24 establishes any packet 18 as an acknowledgment packet.

The header 20 of the synchronization packet may also include a source address of the first device 12 in the source address field 48 of the IP header 26 and a destination address of the second device 14 in the destination address field 50 of the IP header 26. When the second device 14 receives the synchronization packet, it reads each of the source address and destination address from the respective source address field 48 and the destination address field 50 of the IP header 26 of the header 20 of the synchronization packet. The second device 14 then writes the source address to the destination address field 50 of the IP header 26 in the header 20 of the first one of the acknowledgment packets. Similarly, the second device 14 also writes the destination address to the source address field 48 of the IP header 26 and header 20 of the first one of the acknowledgment packets.

The header 20 of the synchronization packet may also include a source port of the program executing in the first device 12 in the source port field 32 of the TCP header 24 and a destination port of the program executing in the second device 14 in the destination port field 34 of the TCP header 24. When the second device 14 receives the synchronization packet, it reads each of the source port and destination port from the respective source port field 32 and the destination port field 34 of the TCP header 24 of the header 20 of the synchronization packet. The second device 14 then writes the source port to the destination port field 34 of the TCP header 24 in the header 20 of the first one of the acknowledgment packets. Similarly, the second device 14 also writes the destination port to the source port field 32 of the TCP header 24 in the header 20 of the first one of the acknowledgment packets.

The header 20 of the synchronization packet may also include a checksum in either of the checksum field 40 of the TCP header 24 and the checksum field 46 of the IP header 26, or in both. When the second device 14 receives the synchronization packet, it reads the checksum from the header 20 of the synchronization packet. The second device 14 then modifies the checksum in accordance with other modifications made to the header 20 of the first one of the acknowledgment packets to obviate recalculation of the checksum. The second device 14 then writes the checksum, as modified, to the appropriate one of the checksum field 40 of the TCP header 24 and the checksum field 46 of the IP header 26 in the header 20 of the first one of the acknowledgment packets.

The preformed final one of the successively transmitted packets may be a termination packet wherein the header 20 of the termination packet includes a predetermined sequence number in the sequence number field 36 of the TCP header 24. The setting of the FIN bit in the control bit field 42 of the TCP header 24 establishes any packet 18 as a termination packet. When the second device 14 receives the termination packet, it reads the sequence number and increments the sequence number. The second device 14 then writes the incremented sequence number to the acknowledgment number field 38 of the TCP header 24 of the header 20 of the final one of the acknowledgment packets.

The header 20 of the termination packet may also include the source address of the first device 12 in the source address field 48 of the IP header 26 and the destination address of the second device 14 in the destination address field 50 of the IP header 26. When the second device 14 receives the termination packet, it reads each of the source address and destination address from the respective source address field 48 and the destination address field 50 of the IP header 26 of the header 20 of the termination packet. The second device 14 then writes the source address to the destination address field 50 of the IP header 26 in the header 20 of the final one of the acknowledgment packets. Similarly, the second device 14 also writes the destination address to the source address field 48 of the IP header 26 and header 20 of the final one of the acknowledgment packets.

The header 20 of the termination packet may also include the source port of the program executing in the first device 12 in the source port field 32 of the TCP header 24 and the destination port of the program executing in the second device 14 in the destination port field 34 of the TCP header 24. When the second device 14 receives the termination packet, it reads each of the source port and destination port from the respective source port field 32 and the destination port field 34 of the TCP header 24 of the header 20 of the termination packet. The second device 14 then writes the source port to the destination port field 34 of the TCP header 24 in the header 20 of the final one of the acknowledgment packets. Similarly, the second device 14 also writes the destination port to the source port field 32 of the TCP header 24 in the header 20 of the final one of the acknowledgment packets.

The header 20 of the termination packet may also include a checksum in either of the checksum field 40 of the TCP header 24 and the checksum field 46 of the IP header 26, or in both. When the second device 14 receives the termination packet, it reads the checksum from the header 20 of the synchronization packet. The second device 14 then modifies the checksum in accordance with other modifications made to the header 20 of the final one of the acknowledgment packets to obviate recalculation of the checksum. The second device 14 then writes the checksum, as modified, to the appropriate one of the checksum field 40 of the TCP header 24 and the checksum field 46 of the IP header 26 in the header 20 of the final one of the acknowledgment packets.

Other than the first one and the final one of the acknowledgment packets, each respective one of the acknowledgment packets is developed in response to receiving the current one of the successively transmitted packets sent by the originating one of the first device 12 and the second device 14. Similarly as described with respect to the first one and the final one of the acknowledgment packets, each of the above fields in the header 20 of the current one of the successively transmitted packets are read, modified as the case may be, and written to the appropriate one of the header fields in the header 20 of the subsequent one of the acknowledgment packets. However, one significant difference exits with respect to developing the acknowledgment number for each respective one of the acknowledgment packets.

The header 20 of each current one of the successively transmitted packets includes the sequence number in the sequence number field of the TCP header 24 and also a length number in the length number field 44 of the IP header 26. The length number is commensurate with the number of the units of data contained within the payload 22.

In the above referenced TCP/IP protocol specifications, the length number is the total length of the datagram. Since the TCP header 24 and the IP header 26 are each of a fixed length, the length number is therefore commensurate with and determinative of the number of units of data in the payload 22.

The originating one of the first device 12 and the second device 14 reads each of the sequence number and the length number from the header 20 of the current one of the successively transmitted packets and develops the acknowledgment number for the respective one of the acknowledgment packets from the sequence number and the length number. The receiving one of the first device 12 and the second device 14 then writes this acknowledgment number to the acknowledgment number field 38 of the TCP header 24 in the header 20 of the respective one of the acknowledgment packets. When the length number refers to the number of units of data in the payload 22, the second device 14 may calculate the acknowledgment number as a sum of the sequence number and the length number.

The header 20 of the current one of the acknowledgment packets received at the originating one of the first device 12 and the second device 14 in acknowledgment of an immediately prior one of the successively transmitted packets includes an acknowledgment number in the acknowledgment number field 38 of the TCP header 24. The originating one of the first device 12 and a second device 14 developing each subsequent one of the successively transmitted packets reads the acknowledgment number from the header 20 of the current one of the acknowledgment packets and develops a sequence number from the acknowledgment number. The originating one then writes the sequence number into the sequence number field 36 of the TCP header 24 for the subsequent one of the successively transmitted packets being developed. To develop the sequence number, the acknowledgment number may, in one embodiment of the present invention, be incremented.

The header 20 of the current one of the acknowledgment packets received in acknowledgment of the immediately prior one of the successively transmitted packets may also include the source address of the originating one of the first device 12 and the second device 14 in the destination address field 50 of the IP header 26 and the destination address of the receiving one of the first device 12 and the second device 14 in the source address field 48 of the IP header 26. The originating one of the first device 12 and the second device 14 developing the subsequent one of the successively transmitted packets reads the source address and the destination address and writes the source address to the source address field 48 of the IP header 26 of the subsequent one of the successively transmitted packets and writes the destination address to the destination address field 50 of the IP header 26 of the subsequent one of the successively transmitted packets.

The header 20 of the current one of the acknowledgment packets received in acknowledgment of the immediately prior one of the successively transmitted packets may also include the source port of the program executing at the originating one of the first device 12 and the second device 14 in the destination port field 34 of the TCP header 24 and the destination port of the program running at the receiving one of the first device 12 and the second device 14 in the source port field 32 of the TCP header 24. The originating one of the first device 12 and the second device 14 developing each subsequent one of the successively transmitted packets reads the source port and the destination port and writes the source port to the source port field 32 of the TCP header 24 of the subsequent one of the successively transmitted packets and writes the destination port to the destination port field 34 of the TCP header 24 of the subsequent one of the successively transmitted packets.

The header 20 of the current one of the acknowledgment packets received in acknowledgment of the immediately prior one of the successively transmitted packets may also include a checksum in either of the checksum field 40 of the TCP header 24 and the checksum field 46 of the IP header 26, or in both. The originating one of the first device 12 and the second device 14 reads the checksum from the header 20 of the current one of the acknowledgment packets. The originating one then modifies the checksum in accordance with other modifications made to the header 20 of the subsequent one of the successively transmitted packets to obviate recalculation of the checksum. The originating one then writes the checksum, as modified, to the appropriate one of the checksum field 40 of the TCP header 24 and the checksum field 46 of the IP header 26 in the header 20 of the subsequent one of the successively transmitted packets.

In the computer system 10, in another embodiment of the present invention, wherein a program executing at the first device 12 and a program executing at the second device 14 exchange data in a plurality of packets 18 transmitted bidirectionally through a connection over the computer network 16 and further wherein each of the packets 18 has the header 20 and the payload 22, the first device 12 may predetermine a total first number of units of data in the payload 22 of all the packets 18 to be transmitted from the first device 12 to the second device 14. Similarly, the second device 14 may predetermine a total second number of units of data in the payload 22 of all the packets 18 to be transmitted from the second device 14 to the first device 12.

The first device 12 preforms a SYN packet to be transmitted to the second device 14 as a first one of the packets 18. The header 20 of the SYN packet includes an initial sequence number associated with the first device 12 in the sequence number field 36 of the TCP header 24.

The first device 12 also preforms a FIN packet as a final one of the packets 18 to be transmitted to the second device 14. The header 20 of the FIN packet includes a final sequence number associated with the first device 12 in the sequence number field 36 of the TCP header 24. The final sequence number is determinable from the first number of units of data.

The second device 14 develops a SYN/ACK packet as a further one of the bidirectionally transmitted packets 18 in response to receipt of the SYN packet. The header 20 of the SYN/ACK packet includes an acknowledgment number in the acknowledgment number field 38 of the TCP header 24. The acknowledgment number is determinable from the initial sequence number associated with the first device 12. The header 20 of the SYN/ACK packet also includes an initial sequence number associated with the second device 14 in the sequence number field 36 of the TCP header 24.

The second device 14 also develops a FIN/ACK packet as a final one of the bidirectionally transmitted packets 18 in response to receipt of the FIN packet. The header 20 of the FIN/ACK packet includes an acknowledgment number in the acknowledgment number field 38 of the TCP header 24 that is determinable from the final sequence number in the header 20 of the FIN packet. The header 20 of the FIN/ACK packet also includes a final sequence number associated with the second device 14 in the sequence number field 36 of the TCP header 24. The final sequence number is determinable from the second number of units of data.

For a SYN packet, the SYN bit is set within the control bit field 42 of the TCP header 24. For a SYN/ACK packet, each of the SYN and ACK bits are set within the control bit field 42 of the TCP header 24. For a FIN packet, the FIN bit is set within the control bit field 42 of the TCP header 24. For a FIN/ACK packet, each of the FIN and ACK bits are set within the control bit field 42 of the TCP header 24.

To develop the SYN/ACK packet the second device 14 reads the initial sequence number associated with the first device 12 upon receipt of the SYN packet. The second device then increments the initial sequence number associated with the first device 12 to develop the acknowledgment number for the SYN/ACK packet and writes this acknowledgment number to the acknowledgment number field 38 of the TCP header 24 of the SYN/ACK packet.

To develop the FIN/ACK packet the second device 14 reads the final sequence number associated with the first device 12 upon receipt of the FIN packet. The second device then increments the final sequence number associated with the first device 12 to develop the acknowledgment number for the FIN/ACK packet and writes this acknowledgment number to the acknowledgment number field 38 of the TCP header 24 of the FIN/ACK packet.

The first device 12 may determine the final sequence number of the FIN packet as a sum of the initial sequence number associated with the first device 12 and the first number of units of data. Similarly, the second device 14 may determine the final sequence number of the FIN/ACK packet and sum of the final sequence number associated with the second device 14 and the second number of units of data.

For each of the SYN packet, the SYN/ACK packet, the FIN packet and the FIN/ACK packet, the source port field 32, the destination port field 34, the sequence number field 36, the acknowledgment number field 38 and the checksum field 40 of the TCP header 24 have their contents read, modified and written as described hereinabove with respect to the first one of the successively transmitted packets, the first one of the acknowledgment packets, the final one of the successively transmitted packets and the final one of the acknowledgment packets, respectively.

Similarly, for each of the SYN packet, the SYN/ACK packet, the FIN packet and the FIN/ACK packet, the length field 44, the checksum field 46, the source address field 48 and the destination address field 50 in the IP header 26 have their contents read, modified and written as described hereinabove with respect to the first one of the successively transmitted packets, the first one of the acknowledgment packets, the final one of the successively transmitted packets and final one of the acknowledgment packets, respectively.

In the one aspect of the present embodiment of the present invention, the header for each one of the packets 18 sent from an originating one of the first device 12 and the second device 14 may be developed as hereinabove described from the header of the current one of the acknowledgment packets sent from the receiving one of the first device 12 and the second device 14 knowledge in receipt of an immediately prior one of the packets 18 sent from the originating one. Similarly, the header for each one of the acknowledgment packets may also be developed as hereinabove described from the header of the respective one of the packets 18 received at the receiving one of the first device 12 and second device 14.

In another aspect of the present embodiment of the present invention, each of packets 18 sent from one of the first device 12 and the second device 14 may contain data in the payload 22 and also acknowledge another one of the packets 18 received from the other one of the first device 12 and the second device 14. Each of the packets 18 containing data in the payload 22 and also acknowledging another one of the packets 18 received has the ACK bit set within the control bit field 42 of the TCP header 24.

For example, the header 20 for a current one of the packets 18 to be sent by one of the first device 12 and the second device 14 may include an acknowledgment number in the acknowledgment number field 38 of the TCP header 24, a sequence number in the sequence number field 36 of the TCP header 24 and a length number in the length number field 44 of the IP header 26. When the current one of the packets 18 is received at the other one of the first device 12 and the second device 14, a next one of the packets 18 is then developed at the other, or receiving, one of the first device 12 and a second device 14.

The receiving one of the first device 12 and the second device 14 reads each of the acknowledgment number, the sequence number and the length number from the header 20 of the received current one of the packets 18. The receiving one of the first device 12 and the second device 14 develops the sequence number for the next one of the packets 18 from the acknowledgment number read from the current one of the packets 18. Similarly, the receiving one of the first device 12 and the second device 14 develops the acknowledgment number for the next one of the packets 18 from the sequence number in the length number from the current one of the packets 18.

The receiving one of the first device 12 and the second device 14 then writes the developed sequence number and the developed acknowledgment number for the next one of the packets 18 into the sequence number field 36 and acknowledgment number field 38, respectively, of the TCP header 24 of the next one of the packets 18. The receiving one of the first device 12 and the second device 14 also develops the length number for the length number field 44 in the IP header 26 for the next one of the packets 18 commensurately with the number of units of data in the payload 22 in the next one of the packets 18.

In the computer system 10, and another embodiment of the present invention, first successive ones of the packets 18 are sent from the first device 12 to the second device 14 and second successive ones of the packets 18 are sent from the second device 14 to the first device 12. Each of the first successive ones and second successive ones of the packets 18 include the header 20 and the payload 22 so that data is exchanged between the first device 12 and second device 14 between programs executing at each of the first device 12 and the second device 14. The header 20 of each of the first successive ones and second successive ones of the packets 18 includes the sequence number in the sequence number field 36 of the TCP header 24, and acknowledgment number in the acknowledgment number field 38 of the TCP header 24, and the length number in the length number field 44 of the IP header 26.

At the first device 12, a SYN packet is preformed to be transmitted to the second device 14. The SYN packet has an initial sequence number associated with the first device 12 in its sequence number field 36. The second device 14 in response to receipt of the SYN packet develops a SYN/ACK packet to be transmitted to the first device 12. The header 20 of the SYN/ACK packet includes an acknowledgment number in the acknowledgment number field 38 and initial sequence number associated with the second device 14 in the sequence number field 36. The acknowledgment number is determinable from the initial sequence number associated with the first device 12.

At the first device 12, a FIN packet is also preformed to be transmitted to the second device 14. The FIN packet has a final sequence number associated with the first device 12 in its sequence number field 36. The final sequence number is determinable from said first number of units of data. The second device 14 in response to receipt of the FIN packet develops a FIN/ACK packet to be transmitted to the first device 12. The header 20 of the SYN/ACK packet includes an acknowledgment number in the acknowledgment number field 38 and a final sequence number associated with the second device 14 in the sequence number field 36. The acknowledgment number is determinable from the initial sequence number associated with the first device 12. The final sequence number is determinable from said number of said second units of data.

For each current one of the first packets to be sent from the first device 12, the first device 12 reads the sequence number, the length number and the acknowledgment number from the header 20 of a respective one of the second packets received at the first device 12 subsequently to an immediately prior one of the first packets being sent by the first device 12. The first device 12 develops for the current one of the first packets each of a current acknowledgment number from the sequence number and the length number from the header 20 of the respective one of the second packets, and a current sequence number from the acknowledgment number of the respective one of the second packets. The first device 12 then writes the current acknowledgment number and the current sequence number to the acknowledgment number field 38 and the sequence number field 36, respectively, of the header 20 of the current one of the first packets.

Similarly, for each current one of the second packets to be sent from the second device 14, the second device 14 reads the sequence number, the length number and the acknowledgment number from the header 20 of a respective one of the first packets received at the second to device 14 subsequently to an immediately prior one of the second packets being sent by the second device 14. The second device 14 develops for the current one of the second packets each of a current acknowledgment number from the sequence number and the length number from the header 20 of the respective one of the first packets, and a current sequence number from the acknowledgment number of the respective one of the first packets. The second device 14 then writes the current acknowledgment number and the current sequence number to the acknowledgment number field 38 and the sequence number field 36, respectively, of the header 20 of the current one of the second packets.

The description of each of the header fields in the header 20 of the first and second packets, the SYN packets, the SYN/ACK packet, the FIN packet and the FIN/ACK packet, as well as the contents of these header fields, are read, modified and written as described above. Such description is accordingly incorporated into description of the presently described embodiment of the invention. Additionally, the setting of an ACK bit in the control field 42 may occur contemporaneously with the writing of the acknowledgment number in the acknowledgment number field 38.

Referring now to FIG. 5A, there is shown a flowchart useful to describe a method of the present invention. In one embodiment of the present invention, the method may be practice in conjunction with a testing environment in which the first device 12 and the second device 14 communicate with each other, similarly as described above, however, with a device under test (DUT) 58 being interposed a first device 12 and the second device 14 within the network 16, as best seen in FIG. 6. The DUT 58 may be any conventional network device, such as a server, router or the like.

For example, the program executing at the first device 12 and the program executing at the second device 14 may be testing routines to determine a maximum rate of establishing connections at or through the device under test 58, or the maximum number of connections possible to be maintained at the device under test 58. The data in the payload 22 of each one of the packets 18 may then be data generated by these testing routines to be transmitted between the first device 12 and the second device 14. More specifically, the data generating at the originating one of the first device 12 in the second device 14 and placed into the payload 22 of the packets 18 originating therefrom may be analyzed at the receiving one of the first device 12 in the second device 14 for to determine the empirical results of the effect of establishing and maintaining connections at the DUT 58.

In accordance with the principles of one embodiment of the present invention, a stateless TCP/IP method includes predetermining, at step 60, a total number of packets or units as data to be sent between the first device 12 and a second device 14. In one particular embodiment of the present invention, a total first number of units of data in the payload 22 of all packets to be transmitted from the first device 12 to the second device 14 and a total of the second member units of data in the payload 22 of all the packets 18 to be transmitted from the second device 14 to the first device 12. The total number of first and second packets is determined for each connection established between the first device 12 and the second device 14. In the testing environment, these connections are also through the device under test 58.

At step 62, the method further includes preforming a SYN packet at the first device 12. The SYN packet is to be transmitted to the second device 14 as a first one of the packets. The header 20 of the SYN packet includes and initial sequence number associated with the first device 12 in the sequence number field 36 of the TCP header 24. The initial sequence member may be randomly generated or may further be preselected.

At step 64, the method further includes preforming a FIN packet at the first device 12 as a final one of the packets 18 to be transmitted to the second device 18. The FIN packet is to be transmitted to the second device 14 as a final one of the packets. The header 20 of the FIN packet includes a final sequence number associated with the first device in the sequence number field 36 of the TCP header 24. The final sequence number is determinable from the first number of units of data and the initial sequence number associated with the first device 12.

In response to receipt of the SYN packet at the second device 14, the method includes, at step 66, developing a SYN/ACK packet at the second device 12. The header 20 of the SYN/ACK packet includes an acknowledgment number in the acknowledgment number field 38 of the TCP header 24. The header 20 of the SYN/ACK packet further includes an initial sequence number associated with the second device 14 in the sequence number field 36 of the TCP header 24. The acknowledgment number in the SYN/ACK packet is determinable from the initial sequence number associated with the first device 12. The initial sequence number associated with the second device 14 may also be randomly generated or predetermined.

At step 68, is indicated that the first ones of the packets 18 are transmitted from the first device 12 to the second device 14 and the second ones of the packets 18 are transmitted from the second device 14 to the first device 12. Step 68 is described in greater detail hereinbelow with reference to FIGS. 5B and 5C.

At step 70, in response to receipt of the FIN packet at the second device 14, the method includes developing a FIN/ACK packet at the second device 14 as a final one of the packets. The header 20 of the FIN/ACK packet includes an acknowledgment number determinable from the final sequence number associated with the first device 12 in the acknowledgment number field 38 of the TCP header 24 and a final sequence number associated with the second device 14 in the sequence number field 36 of the TCP header 24. The final sequence number associated with the second device is determinable from the second number of units of data and the initial sequence number associated with the second device 14.

In conjunction with preforming the test at the DUT 58, the above described method of FIG. 5A would be repeatedly executed at one of the first device 12 and the second device 14 to establish as many connections possible at the DUT 58.

In one embodiment of the present invention, the above described method made that predetermined the total number of units of data or the total number of packets to be transmitted between the first device 12 in the second device 14. Accordingly, the final sequence number associated with the first device 12 and the second device 14 would need to be determined from their respective initial sequence number and the number of units of data actually transmitted from each device.

The header 20 of each of the packets 18 have the sequence number field 36 containing a sequence number of a current one of the packets, a length number field 44 containing a length number of the units of data contained in the payload 22 for such packet, and an acknowledgment number field 38 containing an acknowledgment number.

With reference to FIG. 5B, with respect to a current one of the first packets to be sent, the method may further include reading the sequence number, the length number and the acknowledgment number from the header 20 of a respective one of the second packets received at the first device 12 subsequently to an immediately prior one of the first packets being sent, as indicated at step 72. The method of may further include, at step 74, developing for the current one of the first packets, each of a current acknowledgment number from the sequence number and the length number from the header of the respective one of the second packets, and a current sequence number from the acknowledgment number of the respective one of the second packets. The method may then include, at step 76, writing the current acknowledgment number and the current sequence number to the acknowledgment number field 38 and the sequence number field 36, respectively, of the header 20 of the current one of the first packets.

With reference to FIG. 5C, with respect to a current one of the second packets to be sent, the method may further include reading the sequence number, the length number and the acknowledgment number from the header 20 of a respective one of the first packets received at the second device 14 subsequently to an immediately prior one of the second packets being sent, as indicated at step 78. The method of may further include, at step 80, developing for the current one of the second packets, each of a current acknowledgment number from the sequence number and the length number from the header of the respective one of the first packets, and a current sequence number from the acknowledgment number of the respective one of the first packets. The method may then include, at step 82, writing the current acknowledgment number and the current sequence number to the acknowledgment number field 38 and the sequence number field 36, respectively, of the header 20 of the current one of the second packets.

In the method of the present invention, it is apparent that the header 20 for each of the current first or second packets to be developed uses, to the extent possible, as much information is possible from the immediately prior received one of the packets at either the first device 12 of the second device 14. This statement also holds true for the SYN/ACK packet and the FIN/ACK packet.

For example, in addition to the elements of the header 20 described above, any of the above described packets may have the source address of the one of the first device 12 and the second device 14 developing such packet in the source address field 48 and a destination address of the other one of the first device 12 in the second device 14 in the destination address field 50. Upon this packet being received, the receiving device reads each of the source address and the destination address from the received packet and writes this information, respectively, to the destination address field 50 and the source address field 48 of the new packet to be developed. This statement also holds true for the contents of the source port field 32 and destination port field 34.

Regarding the contents of the checksum field 40 in the TCP header 24 and also the checksum field 46 of the IP header 26, the checksum field is read at the receiving device. However, instead of recalculating the checksum using known checksum algorithms, the checksum may be artificially modified, based upon the new values in the header. For example, it is known that incrementing of a sequence number to develop the new acknowledgment number would have a corresponding effect at the checksum. For example, for each binary 1 added to a sequence number to form an acknowledgment number, a binary one may be subtracted from the read checksum to develop the new checksum. In such way, recalculation of the checksum has been obviated.

There is described hereinabove a novel TCP/IP method and apparatus. Those skilled in the art may not make numerous uses of, and departures from, the above described preferred embodiments without departing from the inventive concepts disclosed herein. Accordingly, the present invention is to be defined solely by the scope of the appended claims.

What is claimed as the invention is:

1. In a computer system wherein a first device and a second device through a connection over a computer network exchange a plurality of successively transmitted packets and a plurality of acknowledgment packets wherein each of said packets has a header and further wherein for a current one of said successively transmitted packets sent from an originating one of said first device and said second device and received at a receiving one of said first device and said second device said receiving one sends a respective one of said acknowledgment packets to said originating one of said first device and said second device, a stateless TCP/IP method comprising steps of:
preforming at said first device a first one of said successively transmitted packets to be transmitted to said second device wherein said header of said first one of said successively transmitted packets includes predetermined information associated with establishing said connection;
for a first one of said acknowledgment packets wherein said header of said first one of said acknowledgment packets includes complementary information associated with establishing said connection, reading selected portions of said header of said first one of said successively transmitted packets, modifying said selected portions from said first one of said successively transmitted packets and writing said selected portions from said first one of said successively transmitted packets into said header of said first one of said acknowledgment packets;
for each subsequent one of said successively transmitted packets, reading selected portions of said header of a current one of said acknowledgment packets received in acknowledgment of an immediately prior one of said successively transmitted packets, modifying said selected portions from said header of said prior one of said acknowledgment packets and writing said selected portions from said header of said prior one of said acknowledgment packets into said header of said subsequent one of said successively transmitted packets;
for each subsequent respective one of said acknowledgment packets, reading selected portions of said header of said current one of said successively transmitted packets, modifying said selected portions from said header of said current one of said successively transmitted packets and writing said selected portions from said header of said current one of said successively transmitted packets into said header of said respective one of said acknowledgment packets;
preforming at said first device a final one of said successively transmitted packets to be transmitted to said second device wherein said header of said final one of said successively transmitted packets includes predetermined information associated with terminating said connection; and
for a final one of said acknowledgment packets wherein said header of said final one of said acknowledgment packets includes complementary information associated with terminating said connection, reading selected portions of said header of said final one of said successively transmitted packets, modifying said selected portions from said final one of said successively transmitted packets and writing said selected portions from said final one of said successively transmitted packets into said header of said final one of said acknowledgment packets.

2. A method as set forth in claim 1 wherein said first one preforming step includes preforming a synchronization packet wherein said header of said synchronization packet includes a predetermined sequence number in a sequence number field.

3. A method as set forth in claim 2 wherein said reading, modifying and writing step for said first one of said acknowledgment packets includes reading said sequence number, incrementing said sequence number and subsequently writing said sequence number to an acknowledgment number field of said header of said first one of said acknowledgment packets.

4. A method as set forth in claim 1 wherein said first one preforming step includes preforming a synchronization packet wherein said header of said synchronization packet includes a source address of said first device in a source address field and a destination address of said second device in a destination address field.

5. A method as set forth in claim 4 wherein said reading, modifying and writing step for said first one of said acknowledgment packets includes reading each of said source address and said destination address and writing said source address to a destination address field of said header of said first one of said acknowledgment packets and writing said destination address to a source address field of said header of said first one of said acknowledgment packets.

6. A method as set forth in claim 1 wherein said first one preforming step includes preforming a synchronization packet wherein said header of said synchronization packet includes a source port of a program executing at said first device in a source port field and a destination port of a program executing at said second device in a destination port field.

7. A method as set forth in claim 6 wherein said reading, modifying and writing step for said first one of said acknowledgment packets includes reading each of said source port and said destination port and writing said source port to a destination port field of said header of said first one of said acknowledgment packets and writing said destination port to a source port field of said header of said first one of said acknowledgment packets.

8. A method as set forth in claim 1 wherein said first one preforming step includes preforming a synchronization packet wherein said header of said synchronization packet includes a checksum in a checksum field.

9. A method as set forth in claim 8 wherein said reading, modifying and writing step for said first one of said acknowledgment packets includes reading said checksum, modifying said checksum in accordance with other modifications made to said header of said first one of said acknowledgment packets to obviate recalculation of said checksum and writing said checksum to a checksum field of said header of said first one of said acknowledgment packets.

10. A method as set forth in claim 1 wherein said header of said current one of said acknowledgment packets received in acknowledgment of said immediately prior one of said successively transmitted packets includes an acknowledgment number in a acknowledgment number field, and wherein said reading, modifying and writing step for each subsequent one of said successively transmitted packets includes reading said acknowledgment number, developing a sequence number from said acknowledgment number and subsequently writing said sequence number to a sequence number field of said header of said subsequent one of said successively transmitted packets.

11. A method as set forth in claim 10 wherein said developing step includes incrementing said acknowledgment number to develop said sequence number.

12. A method as set forth in claim 1 wherein said header of said current one of said acknowledgment packets received in acknowledgment of said immediately prior one of said successively transmitted packets includes a source address of said originating one in a destination address field and a destination address of said receiving one in a source address field, and wherein said reading, modifying and writing step for each subsequent one of said successively transmitted packets includes reading each of said source address and said destination address and writing said source address to a source address field of said header of said subsequent one of said successively transmitted packets and writing said destination address to a destination address field of said header of said subsequent one of said successively transmitted packets.

13. A method as set forth in claim 1 wherein said header of said current one of said acknowledgment packets received in acknowledgment of said immediately prior one of said successively transmitted packets includes a source port of a program executing at said originating one in a destination port field and a destination port of a program executing at said receiving one in a source port field, and wherein said reading, modifying and writing step for each subsequent one of said successively transmitted packets includes reading each of said source port and said destination port and writing said source port to a source port field of said header of said subsequent one of said successively transmitted packets and writing said destination port to a destination port field of said header of said subsequent one of said successively transmitted packets.

14. A method as set forth in claim 1 wherein said header of said current one of said acknowledgment packets received in acknowledgment of said immediately prior one of said successively transmitted packets includes a checksum in a checksum field, and wherein said reading, modifying and writing step for each subsequent one of said successively transmitted packets includes reading said checksum, modifying said checksum in accordance with other modifications made to said header of said subsequent one of said successively transmitted packets to obviate recalculation of said checksum and writing said checksum to a checksum field of said header of said subsequent one of said successively transmitted packets.

15. A method as set forth in claim 1 wherein said header of said current one of said successively transmitted packets includes a sequence number in a sequence number field and a length number in a length number field, and wherein said reading, modifying and writing step for said respective one of said acknowledgment packets includes reading each of said sequence number and said length number, developing an acknowledgment number from said sequence number and said length number, and subsequently writing said acknowledgment number to an acknowledgment number field of said header of said respective one of said acknowledgment packets.

16. A method as set forth in claim 15 wherein said developing step includes calculating said acknowledgment number as a sum of said sequence number and said length number.

17. A method as set forth in claim 1 wherein said header of said current one of said successively transmitted packets includes a source address of said originating one in a source address field and a destination address of said receiving one in a destination address field, and wherein said reading, modifying and writing step for said respective one of said acknowledgment packets includes reading each of said source address and said destination address and writing said source address to a destination address field of said header of said respective one of said acknowledgment packets and writing said destination address to a source address field of said header of said respective one of said acknowledgment packets.

18. A method as set forth in claim 1 wherein said header of said current one of said successively transmitted packets includes a source port of a program executing at said originating one in a source port field and a destination port of a program executing at said receiving one in a destination port field, and wherein said reading, modifying and writing step for said respective one of said acknowledgment packets includes reading each of said source port and said destination port and writing said source port to a destination port field of said header of said respective one of said acknowledgment packets and writing said destination port to a source port field of said header of said respective one of said acknowledgment packets.

19. A method as set forth in claim 1 wherein said header of said current one of each of said successively transmitted packets includes a checksum in a checksum field, and wherein said reading, modifying and writing step for said respective one of said acknowledgment packets includes reading said checksum, modifying said checksum in accordance with other modifications made to said header of said respective one of said acknowledgment packets to obviate recalculation of said checksum and writing said checksum to a checksum field of said header of said respective one of said acknowledgment packets.

20. A method as set forth in claim 1 wherein said final one preforming step includes preforming a termination packet wherein said header of said termination packet includes a predetermined sequence number in a sequence number field.

21. A method as set forth in claim 20 wherein said reading, modifying and writing step for said final one of said acknowledgment packets includes reading said sequence number, incrementing said sequence number and subsequently writing said sequence number to an acknowledgment number field of said header of said final one of said acknowledgment packets.

22. A method as set forth in claim 1 wherein said final one preforming step includes preforming a termination packet wherein said header of said termination packet includes a source address of said final device in a source address field and a destination address of said second device in a destination address field.

23. A method as set forth in claim 22 wherein said reading, modifying and writing step for said final one of said acknowledgment packets includes reading each of said source address and said destination address and writing said source address to a destination address field of said header of said final one of said acknowledgment packets and writing said destination address to a source address field of said header of said final one of said acknowledgment packets.

24. A method as set forth in claim 1 wherein said final one preforming step includes preforming a termination packet wherein said header of said termination packet includes a source port of a program executing at said final device in a source port field and a destination port of a program executing at said second device in a destination port field.

25. A method as set forth in claim 24 wherein said reading, modifying and writing step for said final one of said acknowledgment packets includes reading each of said source port and said destination port and writing said source port to a destination port field of said header of said final one of said acknowledgment packets and writing said destination port to a source port field of said header of said final one of said acknowledgment packets.

26. A method as set forth in claim 1 wherein said final one preforming step includes preforming a termination packet wherein said header of said termination packet includes a checksum in a checksum field.

27. A method as set forth in claim 26 wherein said reading, modifying and writing step for said final one of said acknowledgment packets includes reading said checksum, modifying said checksum in accordance with other modifications made to said header of said final one of said acknowledgment packets to obviate recalculation of said checksum and writing said checksum to a checksum field of said header of said final one of said acknowledgment packets.

28. In a computer system wherein a program executing at a first device and a program executing at a second device exchange data in a plurality of packets transmitted bidirectionally through a connection over a computer network wherein each of said packets has a header and a payload, a stateless TCP/IP method comprising steps of:
predetermining a total first number of units of data in said payload of all of said packets to be transmitted from said first device to said second device and a total second number of units of data in said payload of all of said packets to be transmitted from said second device to said first device;
preforming a SYN packet at said first device to be transmitted to said second device as a first one of said packets wherein said header of said SYN packet includes an initial sequence number associated with said first device in a sequence number field;
preforming a FIN packet at said first device as a final one of said packets to be transmitted to said second device wherein said header of said FIN packet includes a final sequence number associated with said first device in said sequence number field and further wherein said final sequence number is determinable from said first number of units of data;
developing at said second device a SYN/ACK packet as a further one of said packets in response to receipt of said SYN packet wherein said header of said SYN/ACK packet includes an acknowledgment number in an acknowledgment number field and an initial sequence number associated with said second device in said sequence number field and further wherein said acknowledgment number is determinable from said initial sequence number associated with said first device; and
developing at said second device a FIN/ACK packet as a final one of said packets in response to receipt of said FIN packet wherein said header of said FIN/ACK packet includes an acknowledgment number determinable from said final sequence number in said acknowledgment number field and a final sequence number associated with said second device in said sequence number field wherein said final sequence number is determinable from said second number of units of data.

29. A method as set forth in claim 28 wherein said SYN/ACK packet developing step includes reading said initial sequence number associated with said first device upon receipt of said SYN packet, incrementing said initial sequence number associated with said first device to develop said acknowledgment number and writing said acknowledgment number to said acknowledgment number field of said header of said SYN/ACK packet.

30. A method as set forth in claim 28 wherein said FIN/ACK packet developing step includes reading said final sequence number associated with said first device upon receipt of said FIN packet, incrementing said final sequence number associated with said first device to develop said acknowledgment number and writing said acknowledgment number to said acknowledgment number field of said header of said FIN/ACK packet.

31. A method as set forth in claim 28 wherein said FIN packet preforming step includes determining said final sequence number of said FIN packet as a sum of said initial sequence number associated with said first device and said first number of units of data.

32. A method as set forth in claim 28 wherein said FIN/ACK packet developing step includes determining said final sequence number of said FIN/ACK packet as a sum of said initial sequence number associated with said second device and said second number of units of data.

33. A method as set forth in claim 28 wherein said header of said SYN packet includes a source address of said first device in a source address field and a destination address of said second device in a destination address field, and further wherein said SYN/ACK packet developing step includes reading each of said source address and said destination address from said header of said SYN packet and writing said source address to a destination address field of said header of said SYN/ACK packet and writing said destination address to a source address field of said header of said SYN/ACK packet.

34. A method as set forth in claim 28 wherein said header of said SYN packet includes a source port of said program executing at said first device in a source port field and a destination port of said program executing at said second device in a destination port field, and further wherein said SYN/ACK packet developing step includes reading each of said source port and said destination port from said header of said SYN packet and writing said source port to a destination port field of said header of said SYN/ACK packet and writing said destination port to a source port field of said header of said SYN/ACK packet.

35. A method as set forth in claim 28 wherein said header of said SYN packet includes a checksum in a checksum field, and further wherein said SYN/ACK packet developing step includes reading said checksum from said header of said SYN packet, modifying said checksum in accordance with other modifications made to said header of said SYN/ACK packet to obviate recalculation of said checksum and writing said checksum to a checksum field of said header of said SYN/ACK packet.

36. A method as set forth in claim 28 wherein said header of each of said packets sent from an originating one of said first device and said second device to a receiving one of said first device and said second device includes a source address of said originating one in a source address field and a destination address of said receiving one in a destination address field, said method further comprising steps of:
developing at said receiving one of said packets as an acknowledgment packet in response to receiving a current one of said packets;
reading by said receiving one each of said source address and said destination address from said header of said current one and writing said source address to a destination address field of said header of said acknowledgment packet and writing said destination address to a source address field of said header of said acknowledgment packet.

37. A method as set forth in claim 28 wherein said header of each of said packets sent from an originating one of said first device and said second device to a receiving one of said first device and said second device includes a source port of said program executing at said originating one in a source port field and a destination port of said program executing at said receiving one in a destination port field, said method further comprising steps of:
developing at said receiving one of said packets as an acknowledgment packet in response to receiving a current one of said packets;
reading by said receiving one each of said source port and said destination port from said header of said current one and writing said source port to a destination port field of said header of said acknowledgment packet and writing said destination port to a source port field of said header of said acknowledgment packet.

38. A method as set forth in claim 28 wherein said header of each of said packets sent from an originating one of said first device and said second device to a receiving one of said first device and said second device includes a checksum in a checksum field, said method further comprising steps of:
developing at said receiving one of said packets as an acknowledgment packet in response to receiving a current one of said packets;
reading by said receiving one said checksum from said header of said current one, modifying said checksum in accordance with other modifications made to said header of said acknowledgment packet to obviate recalculation of said checksum and writing said checksum to a checksum field of said header of said acknowledgment packet.

39. A method as set forth in claim 28 wherein said header of each of said packets includes a control field having an acknowledgment bit, said method further comprising the step of setting said acknowledgment bit in a current one of said packets to be sent by one of said first device and said second device to indicate acknowledgment of receipt of a prior one of said packets sent by an other one of said first device and said second device.

40. A method as set forth in claim 39 wherein said header of each of said packets includes a sequence number field and an acknowledgment number in an acknowledgment number field, said method further comprising steps of:
reading said acknowledgment number in said header of said prior one of said packets; and
incrementing said acknowledgment number to develop a sequence number; and
writing said sequence number into said header of said current one of said packets.

41. A method as set forth in claim 39 wherein said header of each of said packets includes an acknowledgment number field, a sequence number in a sequence number field and a length number in a length number field, said length number being a number of said units of data, said method further comprising steps of:
reading said sequence number and said length number from said current one of said packets when received at said other one of said first device and said second device;
developing an acknowledgment number from said sequence number and said length number;
writing said acknowledgment number into said acknowledgment number field of a next one of said packets developed at said other one of said first device and said second device to be sent to said one of said first device and said second device; and
setting said acknowledgment bit in said next one of said packets.

42. A method as set forth in claim 41 wherein said acknowledgment number developing step includes calculating said acknowledgment number as a sum of said sequence number and said length number.

43. In a computer system wherein a program executing at a first device and a program executing at a second device exchange data in a plurality of first and second packets transmitted through a connection over a computer network wherein each of said first and second packets includes a header and a payload containing units of said data, said header having a sequence number field containing a sequence number, a length field containing a length number commensurate with a number of said units contained in said payload and an acknowledgment field containing an acknowledgment number, and further wherein said first packets are successively sent from said first device to said second device and said second packets are successively sent from said second device to said first device, a stateless TCP/IP method comprising steps of:
preforming a SYN packet at said first device to be transmitted to said second device wherein said SYN packet includes a header having a sequence number field and an initial sequence number associated with said first device in said sequence number field;
developing at said second device in response to receipt of said SYN packet a SYN/ACK packet to be transmitted to said first device wherein said SYN/ACK packet includes a header having an acknowledgment number field, an acknowledgment number in an acknowledgment number field, a sequence number field and an initial sequence number associated with said second device in said sequence number field and further wherein said acknowledgment number is determinable from said initial sequence number associated with said first device;
for each current one of said first packets to be sent, reading said sequence number, said length number and said acknowledgment number from said header of a respective one of said second packets received at said first device subsequently to an immediately prior one of said first packets being sent, developing for said current one of said first packets each of a current acknowledgment number from said sequence number and said length number from said header of said respective one of said second packets and a current sequence number from said acknowledgment number of said respective one of said second packets, and writing said current acknowledgment number and said current sequence number to said acknowledgment number field and said sequence number field, respectively, of said header of said current one of said first packets;
for each current one of said second packets to be sent, reading said sequence number, said length number and said acknowledgment number from said header of a respective one of said first packets received at said second device subsequently to an immediately prior one of said second packets being sent, developing for said current one of said second packets each of a current acknowledgment number from said sequence number and said length number from said header of said respective one of said first packets and a current sequence number from said acknowledgment number of said respective one of said first packets, and writing said current acknowledgment number for said current one of said second packets and said current sequence number for said current one of said second packets to said acknowledgment number field and said sequence number field, respectively, of said header of said current one of said second packets;
preforming a FIN packet at said first device as a final one of said packets to be transmitted to said second device wherein said header of said FIN packet includes a final sequence number associated with said first device in said sequence number field and further wherein said final sequence number is determinable from said first number of units of data;
developing at said second device a FIN/ACK packet as a final one of said packets in response to receipt of said FIN packet wherein said header of said FIN/ACK includes an acknowledgment number determinable from said final sequence number in said acknowledgment number field and a final sequence number associated with said second device in said sequence number field wherein said final sequence number is determinable from said second number of units of data.

44. A method as set forth in claim 43 wherein said SYN/ACK packet developing step includes reading said initial sequence number associated with said first device upon receipt of said SYN packet, incrementing said initial sequence number associated with said first device to develop said acknowledgment number and writing said acknowledgment number to said acknowledgment number field of said header of said SYN/ACK packet.

45. A method as set forth in claim 43 wherein said FIN/ACK packet developing step includes reading said final sequence number associated with said first device upon receipt of said FIN packet, incrementing said final sequence number associated with said first device to develop said acknowledgment number and writing said acknowledgment number to said acknowledgment number field of said header of said FIN/ACK packet.

46. A method as set forth in claim 43 wherein said FIN packet preforming step includes determining said final sequence number of said FIN packet as a sum of said initial sequence number associated with said first device and said first number of units of data.

47. A method as set forth in claim 43 wherein said FIN/ACK packet developing step includes determining said final sequence number of said FIN/ACK packet as a sum of said initial sequence number associated with said second device and said second number of units of data.

48. A method as set forth in claim 43 wherein said header of said SYN packet includes a source address of said first device in a source address field and a destination address of said second device in a destination address field, and further wherein said SYN/ACK packet developing step includes reading each of said source address and said destination address from said header of said SYN packet and writing said source address to a destination address field of said header of said SYN/ACK packet and writing said destination address to a source address field of said header of said SYN/ACK packet.

49. A method as set forth in claim 43 wherein said header of said SYN packet includes a source port of said program executing at said first device in a source port field and a destination port of said program executing at said second device in a destination port field, and further wherein said SYN/ACK packet developing step includes reading each of said source port and said destination port from said header of said SYN packet and writing said source port to a destination port field of said header of said SYN/ACK packet and writing said destination port to a source port field of said header of said SYN/ACK packet.

50. A method as set forth in claim 43 wherein said header of said SYN packet includes a checksum in a checksum field, and further wherein said SYN/ACK packet developing step includes reading said checksum from said header of said SYN packet, modifying said checksum in accordance with other modifications made to said header of said SYN/ACK packet to obviate recalculation of said checksum and writing said checksum to a checksum field of said header of said SYN/ACK packet.

51. A method as set forth in claim 43 wherein said header of said respective one of said second packets includes a source address of said second device in a source address field and a destination address of said first device in a destination address field, said method further comprising steps of:
developing at said first device said current one of said first packets in response to receiving said respective one of said second packets;
reading by said first device each of said source address and said destination address from said header of said respective one of said second packets and writing said source address to a destination address field of said header of said current one of said first packets and writing said destination address to a source address field of said header of said current one of said first packets.

52. A method as set forth in claim 43 wherein said header of said respective one of said second packets includes a source port of said program executing at said second device in a source port field and a destination port of said program executing at said first device in a destination port field, said method further comprising steps of:
developing at said first device said current one of said first packets in response to receiving said respective one of said second packets;
reading by said first device each of said source port and said destination port from said header of said respective one of said second packets and writing said source port to a destination port field of said header of said current one of said first packets and writing said destination port to a source port field of said header of said current one of said first packets.

53. A method as set forth in claim 43 wherein said header of said respective one of said second packets includes a checksum in a checksum field, said method further comprising steps of:
developing at said first device said current one of said first packets in response to receiving said respective one of said second packets;
reading by said first device said checksum from said header of said respective one of said second packets and writing said checksum to a checksum field of said header of said current one of said first packets.

54. A method as set forth in claim 43 wherein said header of said current one of said first packets includes a control field having an acknowledgment bit, said method further comprising the step of setting said acknowledgment bit in said current one of said first packets to indicate acknowledgment of receipt of said respective one of said second packets.

55. A method as set forth in claim 54 wherein said setting step occurs substantially contemporaneously with said current acknowledgment number writing step.

56. A method as set forth in claim 54 wherein said current sequence number for said current one of said first packets developing step includes the step of incrementing said acknowledgment number from said respective one of said second packets.

57. A method as set forth in claim 56 wherein said current acknowledgment number for said current one of said first packets developing step includes calculating said acknowledgment number for said current one of said first packets as a sum of said sequence number and said length number from said header of said respective one of said second packets.

58. A method as set forth in claim 43 wherein said header of said respective one of said first packets includes a source address of said first device in a source address field and a destination address of said second device in a destination address field, said method further comprising steps of:
developing at said second device said current one of said second packets in response to receiving said respective one of said first packets;
reading by said second device each of said source address and said destination address from said header of said respective one of said first packets and writing said source address to a destination address field of said header of said current one of said second packets and writing said destination address to a source address field of said header of said current one of said second packets.

59. A method as set forth in claim 43 wherein said header of said respective one of said first packets includes a source port of said program executing at said first device in a source port field and a destination port of said program executing at said second device in a destination port field, said method further comprising steps of:
developing at said second device said current one of said second packets in response to receiving said respective one of said first packets;
reading by said second device each of said source port and said destination port from said header of said respective one of said first packets and writing said source port to a destination port field of said header of said current one of said second packets and writing said destination port to a source port field of said header of said current one of said second packets.

60. A method as set forth in claim 43 wherein said header of said respective one of said first packets includes a checksum in a checksum field, said method further comprising steps of:
developing at said second device said current one of said second packets in response to receiving said respective one of said first packets;
reading by said second device said checksum from said header of said respective one of said first packets and writing said checksum to a checksum field of said header of said current one of said second packets.

61. A method as set forth in claim 43 wherein said header of said current one of said second packets includes a control field having an acknowledgment bit, said method further comprising the step of setting said acknowledgment bit in said current one of said second packets to indicate acknowledgment of receipt of said respective one of said first packets.

62. A method as set forth in claim 61 wherein said setting step occurs substantially contemporaneously with said current acknowledgment number writing step.

63. A method as set forth in claim 61 wherein said current sequence number for said current one of said second packets developing step includes the step of incrementing said acknowledgment number from said respective one of said first packets.

64. A method as set forth in claim 63 wherein said current acknowledgment number for said current one of said second packets developing step includes calculating said acknowledgment number for said current one of said second packets as a sum of said sequence number and said length number from said header of said respective one of said first packets.

65. In a computer system wherein a first device and a second device through a connection over a computer network exchange a plurality of successively transmitted packets and a plurality of acknowledgment packets wherein each of said packets has a header and further wherein for a current one of said successively transmitted packets sent from an originating one of said first device and said second device and received at a receiving one of said first device and said second device said receiving one sends a respective one of acknowledgment packets to said originating one of said first device and said second device, a stateless TCP/IP apparatus comprising:
a first one of said successively transmitted packets being preformed at said first device to be transmitted to said second device, said header of said first one of said successively transmitted packets including predetermined information associated with establishing said connection;
a first one of said acknowledgment packets being developed at said second device in response to receipt of said first one of said successively transmitted packets said second device reads selected portions of said header of said first one of said successively transmitted packets, modifies said selected portions from said first one of said successively transmitted packets and writes said selected portions from said first one of said successively transmitted packets into said header of said first one of said acknowledgment packets, said header of said first one of said acknowledgment packets including complementary information associated with establishing said connection;
for each subsequent one of said successively transmitted packets sent by said originating one, said originating one reads selected portions of said header of a current one of said acknowledgment packets received in acknowledgment of an immediately prior one of said successively transmitted packets, modifies said selected portions from said header of said prior one of said acknowledgment packets and writes said selected portions from said header of said prior one into said header of said subsequent one of said successively transmitted packets;
for each subsequent respective one of said acknowledgment packets, said receiving one reads selected portions of said header of said current one of said successively transmitted packets, modifies said selected portions of said header from said current one of said successively transmitted packets and writes said selected portions of said header from said current one of said successively transmitted packets into said header of said respective one of said acknowledgment packets;
a final one of said successively transmitted packets being preformed at said first device to be transmitted to said second device, said header of said final one of said packets including predetermined information associated with terminating said connection; and
a final one of said acknowledgment packets being developed at said second device in response to receipt of said final one of said successively transmitted packets, said header of said final one of said acknowledgment packets including complementary information associated with terminating said connection, said second device reads selected portions of said header of said final one of said successively transmitted packets, modifies said selected portions from said final one of said successively transmitted packets and writes said selected portions from said final one of said successively transmitted packets into said header of said final one of said acknowledgment packets.

66. An apparatus as set forth in claim 65 wherein said first one of said successively transmitted packets includes a synchronization packet having a header, said header of said synchronization packet including a sequence number field containing a sequence number.

67. An apparatus as set forth in claim 66 wherein said header of said first one of said acknowledgment packets includes an acknowledgment number field, said second device reads said sequence number, increments said sequence number and subsequently writes said sequence number to said acknowledgment number field of said header of said first one of said acknowledgment packets.

68. An apparatus as set forth in claim 65 wherein said first one of said successively transmitted packets includes a synchronization packet having a header, said header of said synchronization packet including a source address field containing a source address of said first device and a destination address field containing a destination address of said first device.

69. An apparatus as set forth in claim 68 wherein said header of a source address field and a destination address field, said second device reads said first one of said acknowledgment packets includes reading each of said source address and said destination address and writes said source address to said destination address field of said header of said first one of said acknowledgment packets and writes said destination address to said source address field of said header of said first one of said acknowledgment packets.

70. An apparatus as set forth in claim 65 wherein said first one of said successively transmitted packets includes a synchronization packet having a header, said header of said synchronization packet including a source port field containing a source port of a program executing at said first device and a destination port field containing a destination port of a program executing at said second device.

71. An apparatus as set forth in claim 70 wherein said header of said first one of said acknowledgment packets includes a source port field and a destination port field, said second device reads each of said source port and said destination port and writes said source port to said destination port field of said header of said first one of said acknowledgment packets and writes said destination port to said source port field of said header of said first one of said acknowledgment packets.

72. An apparatus as set forth in claim 65 wherein said first one of said successively transmitted packets includes a synchronization packet having a header, said header of said synchronization packet includes a checksum field containing a checksum.

73. An apparatus as set forth in claim 72 wherein said header of said first one of said acknowledgment packets includes a checksum field, said second device reads said checksum, modifying said checksum in accordance with other modifications made to said header of said first one of said acknowledgment packets to obviate recalculation of said checksum and writes said checksum to said checksum field of said header of said first one of said acknowledgment packets.

74. An apparatus as set forth in claim 65 wherein said header of said current one of said acknowledgment packets received in acknowledgment of said immediately prior one of said successively transmitted packets includes an acknowledgment number field containing an acknowledgment number, and said header of each subsequent one of said successively transmitted packets includes a sequence number field, said originating one reads said acknowledgment number, develops a sequence number from said acknowledgment number and writes said sequence number to said sequence number field of said header of said subsequent one of said successively transmitted packets.

75. An apparatus as set forth in claim 74 wherein said originating one increments said acknowledgment number to develop said sequence number.

76. An apparatus as set forth in claim 65 wherein said header of said current one of said acknowledgment packets received in acknowledgment of said immediately prior one of said successively transmitted packets includes a destination address field containing a source address of said originating one and a source address field containing a destination address of said receiving one and said header of each subsequent one of said successively transmitted packets includes a source address field and a destination address field, said originating one reads each of said source address and said destination address and writes said source address to said destination address field of said header of said subsequent one of said successively transmitted packets.

77. An apparatus as set forth in claim 65 wherein said header of said current one of said acknowledgment packets received in acknowledgment of said immediately prior one of said successively transmitted packets includes a destination port field containing a source port of a program executing at said originating one and a destination port of a program executing at said receiving one a source port field containing, and said header of each subsequent one of said successively transmitted packets includes a source port field and a destination port field, said originating one read each of said source port and said destination port and writes said source port to said source port field of said header of said subsequent one of said successively transmitted packets and writes said destination port to said destination port field of said header of said subsequent one of said successively transmitted packets.

78. An apparatus as set forth in claim 65 wherein said header of said current one of said acknowledgment packets received in acknowledgment of said immediately prior one of said successively transmitted packets includes a checksum field containing a checksum, and wherein said header of each subsequent one of said successively transmitted packets includes a checksum field, said originating one reads said checksum, modifies said checksum in accordance with other modifications made to said header of said subsequent one of said successively transmitted packets to obviate recalculation of said checksum and writes said checksum to said checksum field of said header of said subsequent one of said successively transmitted packets.

79. An apparatus as set forth in claim 65 wherein said header of said current one of said successively transmitted packets includes a sequence number field containing a sequence number and a length number field containing a length number, and said header of said respective one of said acknowledgment packets includes an acknowledgment number field, said receiving one reads each of said sequence number and said length number, develops an acknowledgment number from said sequence number and said length number, and writes said acknowledgment number to said acknowledgment number field of said header of said respective one of said acknowledgment packets.

80. An apparatus as set forth in claim 79 wherein said receiving one calculates said acknowledgment number as a sum of said sequence number and said length number.

81. An apparatus as set forth in claim 65 wherein said header of said current one of said successively transmitted packets includes a source address field containing said source address of said originating one and a destination address field containing said destination address of said receiving one and said header for said respective one of said acknowledgment packets includes a source address field and a destination address field, said receiving one reads each of said source address and said destination address and writes said source address to said destination address field of said header of said respective one of said acknowledgment packets and writes said destination address to said source address field of said header of said respective one of said acknowledgment packets.

82. An apparatus as set forth in claim 65 wherein said header of said current one of said successively transmitted packets includes a source port field containing a source port of a program executing at said originating one and a destination port field containing a destination port of a program executing at said receiving one and wherein said reading, modifying and writing step for said respective one of said acknowledgment packets includes reading each of said source port and said destination port and writing said source port to said destination port field of said header of said respective one of said acknowledgment packets and writing said destination port to said source port field of said header of said respective one of said acknowledgment packets.

83. An apparatus as set forth in claim 65 wherein said header of said current one of said successively transmitted packets includes a checksum field containing a checksum, and said header of said respective one of said acknowledgment packets includes a checksum field, said receiving one reads said checksum, modifies said checksum in accordance with other modifications made to said header of said respective one of said acknowledgment packets to obviate recalculation of said checksum and writes said checksum to said checksum field of said header of said respective one of said acknowledgment packets.

84. An apparatus as set forth in claim 65 wherein said final one preforming step includes preforming a termination packet wherein said header of said termination packet includes a predetermined sequence number in a sequence number field.

85. An apparatus as set forth in claim 84 wherein said reading, modifying and writing step for said final one of said acknowledgment packets includes reading said sequence number, incrementing said sequence number and subsequently writing said sequence number to an acknowledgment number field of said header of said final one of said acknowledgment packets.

86. An apparatus as set forth in claim 65 wherein said final one preforming step includes preforming a termination packet wherein said header of said termination packet includes a source address of said final device in a source address field and a destination address of said second device in a destination address field.

87. An apparatus as set forth in claim 86 wherein said reading, modifying and writing step for said final one of said acknowledgment packets includes reading each of said source address and said destination address and writing said source address to a destination address field of said header of said final one of said acknowledgment packets and writing said destination address to a source address field of said header of said final one of said acknowledgment packets.

88. An apparatus as set forth in claim 65 wherein said final one preforming step includes preforming a termination packet wherein said header of said termination packet includes a source port of a program executing at said final device in a source port field and a destination port of a program executing at said second device in a destination port field.

89. An apparatus as set forth in claim 88 wherein said reading, modifying and writing step for said final one of said acknowledgment packets includes reading each of said source port and said destination port and writing said source port to a destination port field of said header of said final one of said acknowledgment packets and writing said destination port to a source port field of said header of said final one of said acknowledgment packets.

90. An apparatus as set forth in claim 65 wherein said final one preforming step includes preforming a termination packet wherein said header of said termination packet includes a checksum in a checksum field.

91. An apparatus as set forth in claim 90 wherein said reading, modifying and writing step for said final one of said acknowledgment packets includes reading said checksum, modifying said checksum in accordance with other modifications made to said header of said final one of said acknowledgment packets to obviate recalculation of said checksum and writing said checksum to a checksum field of said header of said final one of said acknowledgment packets.

92. In a computer system wherein a program executing at a first device and a program executing at a second device exchange data in a plurality of packets transmitted bidirectionally through a connection over a computer network and further wherein each of said packets has a header and a payload, a stateless TCP/IP apparatus comprising:
a predetermined total first number of units of data in said payload of all of said packets to be transmitted from said first device to said second device and a predetermined total second number of units of data in said payload of all of said packets to be transmitted from said second device to said first device;
a SYN packet preformed at said first device to be transmitted to said second device as a first one of said packets, said SYN packet including a header having a sequence number field containing an initial sequence number associated with said first device;
a FIN packet preformed at said first device as a final one of said packets to be transmitted to said second device, said FIN packet including a header having a sequence number field containing a final sequence number associated with said first device, said final sequence number being determinable from said first number of units of data;
a SYN/ACK packet, said SYN/ACK packet including a header having an acknowledgment number field and a sequence number field, said acknowledgment number field containing an acknowledgment number determinable from said initial sequence number in said sequence number field of said CYN packet, said sequence number field of said SYN/ACK packet having an initial sequence number associated with said device developed at said second device to be transmitted to said first device; and
a FIN/ACK packet, said FIN/ACK packet including a header having as a final one of said packets in response to receipt of said FIN packet an acknowledgment number field and a sequence number field, said acknowledgment number field containing an acknowledgment number determinable from said final sequence number in said sequence number field of said FIN packet, said sequence number field of said FIN/ACK packet containing a sequence number determinable from said second number of units of data.

93. An apparatus as set forth in claim 92 wherein said second device reads said initial sequence number associated with said first device upon receipt of said SYN packet, increments said initial sequence number associated with said first device to develop said acknowledgment number for said header of said SYN/ACK packet and writes said acknowledgment number for said header of said SYN/ACK packet to said acknowledgment number field of said header of said SYN/ACK packet.

94. An apparatus as set forth in claim 92 wherein second device to develop said FIN/ACK packet reads said final sequence number associated with said first device upon receipt of said FIN packet, increments said final sequence number associated with said first device to develop said acknowledgment number for said header of said FIN/ACK packet and writes said acknowledgment number for said header of said FIN/ACK packet to said acknowledgment number field of said header of said FIN/ACK packet.

95. An apparatus as set forth in claim 92 wherein said first device determines said final sequence number of said FIN packet as a sum of said initial sequence number associated with said first device and said first number of units of data.

96. An apparatus as set forth in claim 92 wherein said second device determines said final sequence number of said FIN/ACK packet as a sum of said initial sequence number associated with said second device and said second number of units of data.

97. An apparatus as set forth in claim 92 wherein said header of said SYN packet includes a source address of said first device in a source address field and a destination address of said second device in a destination address field, and further wherein said header of said SYN/ACK packet includes a source address field and a destination address field, said second device reads each of said source address and said destination address from said header of said SYN packet and writing said source address to said destination address field of said header of said SYN/ACK packet and writes said destination address to said source address field of said header of said SYN/ACK packet.

98. An apparatus as set forth in claim 92 wherein said header of said SYN packet includes a source port of said program executing at said first device in a source port field and a destination port of said program executing at said second device in a destination port field, and further wherein said headers said SYN/ACK packet includes a source port field and a destination port field, said second device reads each of said source port and said destination port from said header of said SYN packet and writes said source port to said destination port field of said header of said SYN/ACK packet and writing said destination port to said source port field of said header of said SYN/ACK packet.

99. An apparatus as set forth in claim 92 wherein said header of said SYN packet includes a checksum in a checksum field, and further wherein said header of said SYN/ACK packet includes a checksum field, said second device reads said checksum from said header of said SYN packet, modifies said checksum in accordance with other modifications made to said header of said SYN/ACK packet to obviate recalculation of said checksum and writes said checksum to said checksum field of said header of said SYN/ACK packet.

100. An apparatus as set forth in claim 92 wherein said header of each of said packets sent from an originating one of said first device and said second device to a receiving one of said first device and said second device includes a source address of said originating one in a source address field and a destination address of said receiving one in a destination address field, said apparatus further comprising:
an acknowledgment packet including a header having a source address field and a destination address field developed at said receiving one in response to receiving a current one of said packets from said originating one;
wherein by said receiving one reads each of said source address and said destination address from said header of said current one and writes said source address to said destination address field of said header of said acknowledgment packet and writes said destination address to said source address field of said header of said acknowledgment packet.

101. An apparatus as set forth in claim 92 wherein said header of each of said packets sent from an originating one of said first device and said second device to a receiving one of said first device and said second device includes a source port of said program executing at said originating one in a source port field and a destination port of said program executing at said receiving one in a destination port field, said apparatus further comprising:
an acknowledgment packet including a header having a source port field and a destination port field developed at said receiving one in response to receiving a current one of said packets from said originating one;
wherein said receiving one reads each of said source port and said destination port from said header of said current one and writes said source port to said destination port field of said header of said acknowledgment packet and writes said destination port to said source port field of said header of said acknowledgment packet.

102. An apparatus as set forth in claim 92 wherein said header of each of said packets sent from an originating one of said first device and said second device to a receiving one of said first device and said second device includes a checksum in a checksum field, said apparatus further comprising:
an acknowledgment packet including a header having a checksum field developed at said receiving one in response to receiving a current one of said packets from said originating one;
wherein said receiving one reads said checksum from said header of said current one, modifies said checksum in accordance with other modifications made to said header of said acknowledgment packet to obviate recalculation of said checksum and writes said checksum to said checksum field of said header of said acknowledgment packet.

103. An apparatus as set forth in claim 92 wherein said header of each of said packets includes a control field having an acknowledgment bit, said acknowledgment bit in a current one of said packets to be sent by one of said first device and said second device being set to indicate acknowledgment of receipt of a prior one of said packets sent by an other one of said first device and said second device.

104. An apparatus as set forth in claim 103 wherein said header of each of said packets includes a sequence number field and an acknowledgment number in an acknowledgment number field, said one of said first device and said second device reads said acknowledgment number in said header of said prior one of said packets, increments said acknowledgment number to develop a current sequence number, and writes said sequence number into said header of said current one of said packets.

105. An apparatus as set forth in claim 103 wherein said header of each of said packets includes an acknowledgment number field, a sequence number in a sequence number field and a length number in a length number field, said length number being a number of said units of data, said other one of said first device and said second device reads said sequence number and said length number from said current one of said packets, develops an acknowledgment number from said sequence number and said length number, writes said acknowledgment number into said acknowledgment number field of a next one of said packets developed at said other one of said first device and said second device to be sent to said one of said first device and sets said acknowledgment bit in said next one of said packets.

106. An apparatus as set forth in claim 105 wherein said acknowledgment number is calculated as a sum of said sequence number and said length number.

107. In a computer system wherein a program executing at a first device and a program executing at a second device exchange data in a plurality of packets transmitted bidirectionally through a connection over a computer network wherein each of said packets includes a header and a payload containing units of said data, said header having a sequence number field containing a sequence number, a length field containing a length number commensurate with a number of said units contained in said payload and an acknowledgment field containing an acknowledgment number, and further wherein first successive ones of said packets are sent from said first device to said second device and second successive ones of said packets are sent from said second device to said first device, a stateless TCP/IP apparatus comprising:
a SYN packet preformed at said first device to be transmitted to said second device, said SYN packet including a header having a sequence number field and an initial sequence number associated with said first device in said sequence number field;
a SYN/ACK packet developed at said second device in response to receipt of said SYN packet to be transmitted to said first device, said SYN/ACK packet including a header having an acknowledgment number field, an acknowledgment number in said acknowledgment number field, a sequence number field and an initial sequence number associated with said second device in said sequence number field, said acknowledgment number being determinable from said initial sequence number associated with said first device;
for each current one of said first packets to be sent, said first device said sequence number, said length number and said acknowledgment number from said header of a respective one of said second packets received at said first device subsequently to an immediately prior one of said first packets being sent, develops for said current one of said first packets each of a current acknowledgment number from said sequence number and said length number from said header of said respective one of said second packets and a current sequence number from said acknowledgment number of said respective one of said second packets, and writes said current acknowledgment number and said current sequence number to said acknowledgment number field and said sequence number field, respectively, of said header of said current one of said first packets;
for each current one of said second packets to be sent, said second device reads said sequence number, said length number and said acknowledgment number from said header of a respective one of said first packets received at said second device subsequently to an immediately prior one of said second packets being sent, develops for said current one of said second packets each of a current acknowledgment number from said sequence number and said length number from said header of said respective one of said first packets and a current sequence number from said acknowledgment number of said respective one of said first packets, and writes said current acknowledgment number for said current one of said second packets and said current sequence number for said current one of said second packets to said acknowledgment number field and said sequence number field, respectively, of said header of said current one of said second packets;
a FIN packet preformed at said first device as a final one of said packets to be transmitted to said second device, said FIN packet including a header having a sequence number field and a final sequence number associated with said first device in said sequence number field, said final sequence number being determinable from said initial sequence number associated with said first device and said first number of units of data; and
a FIN/ACK packet developed at said second device in response to receipt of said FIN packet, said FIN/ACK including an acknowledgment number field and a sequence number field, said acknowledgment number field having an acknowledgment number determinable from said final sequence number and said sequence number field having a final sequence number associated with said second device, said final sequence number being determinable from said initial sequence number associated with said second device and said second number of units of data.

108. An apparatus as set forth in claim 107 wherein said second device reads said initial sequence number associated with said first device upon receipt of said SYN packet, increments said initial sequence number associated with said first device to develop said acknowledgment number and writes said acknowledgment number to said acknowledgment number field of said header of said SYN/ACK packet.

109. An apparatus as set forth in claim 107 wherein said second device reads said final sequence number associated with said first device upon receipt of said FIN packet, increments said final sequence number associated with said first device to develop said acknowledgment number and writes said acknowledgment number to said acknowledgment number field of said header of said FIN/ACK packet.

110. An apparatus as set forth in claim 107 wherein said final sequence number of said FIN packet is determined as a sum of said initial sequence number associated with said first device and said first number of units of data.

111. An apparatus as set forth in claim 107 wherein said final sequence number of said FIN/ACK packet is determined as a sum of said initial sequence number associated with said second device and said second number of units of data.

112. An apparatus as set forth in claim 107 wherein said header of said SYN packet includes a source address of said first device in a source address field and a destination address of said second device in a destination address field, and further wherein said header of said SYN/ACK packet includes a source address field and a destination address field, said second device reads each of said source address and said destination address from said header of said SYN packet and writes said source address to said destination address field of said header of said SYN/ACK packet and writes said destination address to said source address field of said header of said SYN/ACK packet.

113. An apparatus as set forth in claim 107 wherein said header of said SYN packet includes a source port of said program executing at said first device in a source port field and a destination port of said program executing at said second device in a destination port field, and further wherein said header of said SYN/ACK packet includes a source port field and a destination port field, said second device reads each of said source port and said destination port from said header of said SYN packet and writes said source port to said destination port field of said header of said SYN/ACK packet and writes said destination port to said source port field of said header of said SYN/ACK packet.

114. An apparatus as set forth in claim 107 wherein said header of said SYN packet includes a checksum in a checksum field, and further wherein said header of said SYN/ACK packet includes a checksum field, said second device reads said checksum from said header of said SYN packet, modifies said checksum in accordance with other modifications made to said header of said SYN/ACK packet to obviate recalculation of said checksum and writes said checksum to said checksum field of said header of said SYN/ACK packet.

115. An apparatus as set forth in claim 107 wherein said header of said respective one of said second packets includes a source address of said second device in a source address field and a destination address of said first device in a destination address field, said current one of said first packets being developed at said first device in response to receiving said respective one of said second packets, wherein said first device reads each of said source address and said destination address from said header of said respective one of said second packets and writes said source address to a destination address field of said header of said current one of said first packets and writing said destination address to a source address field of said header of said current one of said first packets.

116. An apparatus as set forth in claim 107 wherein said header of said respective one of said second packets includes a source port of said program executing at said second device in a source port field and a destination port of said program executing at said first device in a destination port field, said current one of said first packets being developed at said first device in response to receiving said respective one of said second packets, wherein said first device reads each of said source port and said destination port from said header of said respective one of said second packets and writes said source port to a destination port field of said header of said current one of said first packets and writes said destination port to a source port field of said header of said current one of said first packets.

117. An apparatus as set forth in claim 107 wherein said header of said respective one of said second packets includes a checksum in a checksum field, said current one of said first packets being developed at said first device in response to receiving said respective one of said second packets, wherein said first device reads said checksum from said header of said respective one of said second packets and writes said checksum to a checksum field of said header of said current one of said first packets.

118. An apparatus as set forth in claim 107 wherein said header of said current one of said first packets includes a control field having an acknowledgment bit, said acknowledgment bit being set in said current one of said first packets to indicate acknowledgment of receipt of said respective one of said second packets.

119. An apparatus as set forth in claim 118 wherein said acknowledgment bit is set substantially contemporaneously with said current acknowledgment number being written.

120. An apparatus as set forth in claim 118 wherein said current sequence number for said current one of said first packets is developed by incrementing said acknowledgment number from said respective one of said second packets.

121. An apparatus as set forth in claim 120 wherein said current acknowledgment number for said current one of said first packets is calculated as a sum of said sequence number and said length number from said header of said respective one of said second packets.

122. An apparatus as set forth in claim 107 wherein said header of said respective one of said first packets includes a source address of said first device in a source address field and a destination address of said second device in a destination address field, said current one of said second packets being developed at said second device in response to receiving said respective one of said first packets, wherein said second device reads each of said source address and said destination address from said header of said respective one of said first packets and writes said source address to a destination address field of said header of said current one of said second packets and writes said destination address to a source address field of said header of said current one of said second packets.

123. An apparatus as set forth in claim 107 wherein said header of said respective one of said first packets includes a source port of said program executing at said first device in a source port field and a destination port of said program executing at said second device in a destination port field, said current one of said second packets being developed at said second device in response to receiving said respective one of said first packets, wherein said second device reads each of said source port and said destination port from said header of said respective one of said first packets and writes said source port to a destination port field of said header of said current one of said second packets and writes said destination port to a source port field of said header of said current one of said second packets.

124. An apparatus as set forth in claim 107 wherein said header of said respective one of said first packets includes a checksum in a checksum field, said current one of said second packets being developed at said second device in response to receiving said respective one of said first packets, wherein said second device reads said checksum from said header of said respective one of said first packets and writes said checksum to a checksum field of said header of said current one of said second packets.

125. An apparatus as set forth in claim 107 wherein said header of said current one of said second packets includes a control field having an acknowledgment bit, said acknowledgment bit being set in said current one of said second packets to indicate acknowledgment of receipt of said respective one of said first packets.

126. An apparatus as set forth in claim 125 wherein said acknowledgment bit is set substantially contemporaneously with said current acknowledgment number being written.

127. An apparatus as set forth in claim 125 wherein said current sequence number for said current one of said second packets is developed by incrementing said acknowledgment number from said respective one of said first packets.

128. An apparatus as set forth in claim 127 wherein said current acknowledgment number for said current one of said second packets is calculated as a sum of said sequence number and said length number from said header of said respective one of said first packets.
